(19) United States
(12) Patent Application Publication
(10) Pub. No.: US 2002/0096118 A1
(43) Pub. Date: Jul. 25, 2002

(54) Pet bed

(76) Inventor: Kevin L. Kolozsvari, Tustin, CA (US)

Correspondence Address: Richard E. Bee, Weinberg Legal Group, 2390 East Camelback Road (Suite 250), Phoenix, AZ, 85016, US

(21) Appl. No.: 09/768,180

(22) Filed: Jan. 23, 2001

(51) Int. Cl. A01K 29/00

(52) U.S. Cl. 119/28.5

(57) ABSTRACT

An improved pet bed for cats and small dogs, such pet bed including an upwardly extending base which encircles an open center area. Such pet bed also includes a sheet of flexible material sized and shaped to cover most of the open center area. Attachment members are provided for attaching peripheral portions of the flexible material to the inner wall of the base at a level partway up the base. A cushion is located in the open center area of the base and supported by the flexible material.

### TECHNICAL FIELD

This invention relates to beds for pets such as cats and small dogs.

### BACKGROUND OF THE INVENTION

Various and sundry designs have been provided for dog and cat beds. One such design takes the form of a basket which is placed on the floor and has a cushion or some other form of padding placed in it for the comfort of the dog or cat. Designs of this type have various disadvantages. For one thing, the basket is too close to the floor, which may be cold and damp. For another thing, the bed is too hard and stiff and doesn't properly support the body of the animal in the most desirable manner.

### SUMMARY OF THE INVENTION

The present invention provides an improved pet bed that gets the animal off the floor and provides a more form fitting sleeping surface. A pet bed constructed in accordance with the present invention includes an upwardly extending base which encircles an open center area. It also includes a sheet of flexible material which is sized and shaped to cover most of the open center area. It further includes attachment members for attaching peripheral portions of the flexible material to the inner wall of the base at a level partway up the base.

For a better understanding of the present invention, together with other and further advantages and features thereof, reference is made to the following description taken in connection with the accompanying drawings, the scope of the invention being pointed out in the appended claims.

### BRIEF DESCRIPTION OF THE DRAWINGS

Referring to the drawings:

FIG. 1 is a perspective view of a representative embodiment of a pet bed constructed in accordance with the present invention;

FIG. 2 is a perspective view of the pet bed of FIG. 1 with the cushion removed;

FIG. 3 is an enlarged cross-sectional view taken along section line 3-3 of FIG. 1;

FIG. 4 is an enlarged fragmentary view taken from the underside of the pet bed of FIG. 1 and showing how an attachment strap is attached to the flexible material and to the base of the pet bed;

FIG. 5 is a top plan view of the pet bed of FIG. 1 with the cushion removed; and

FIG. 6 is a bottom plan view showing the underside of the pet bed of FIG. 1.

### DETAILED DESCRIPTION OF THE ILLUSTRATED EMBODIMENT

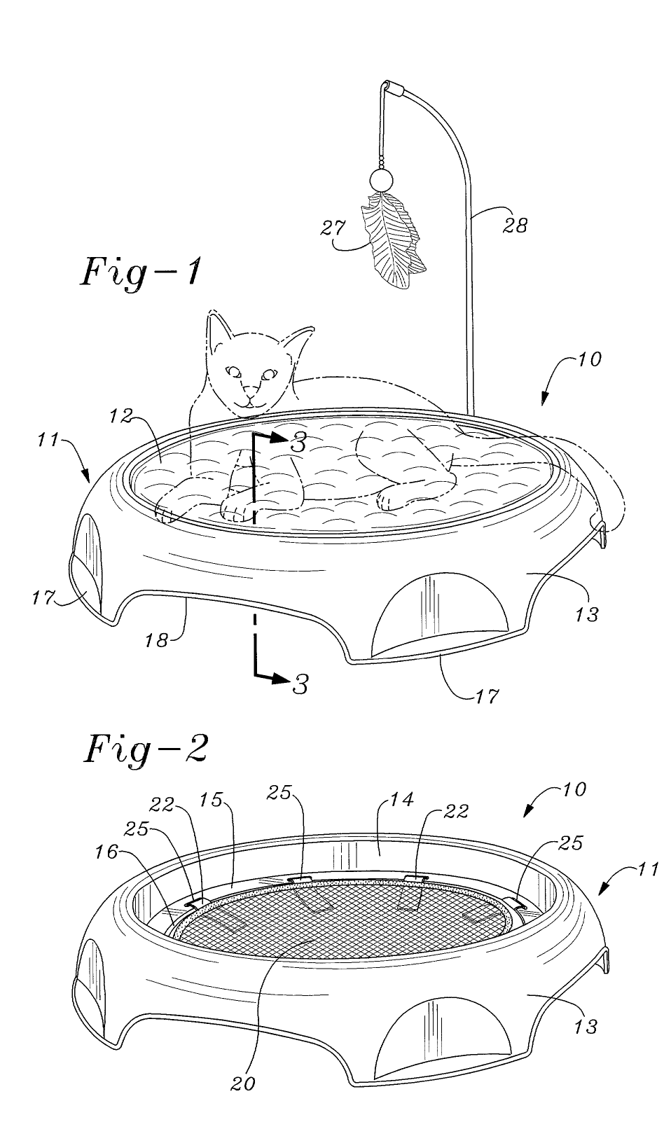

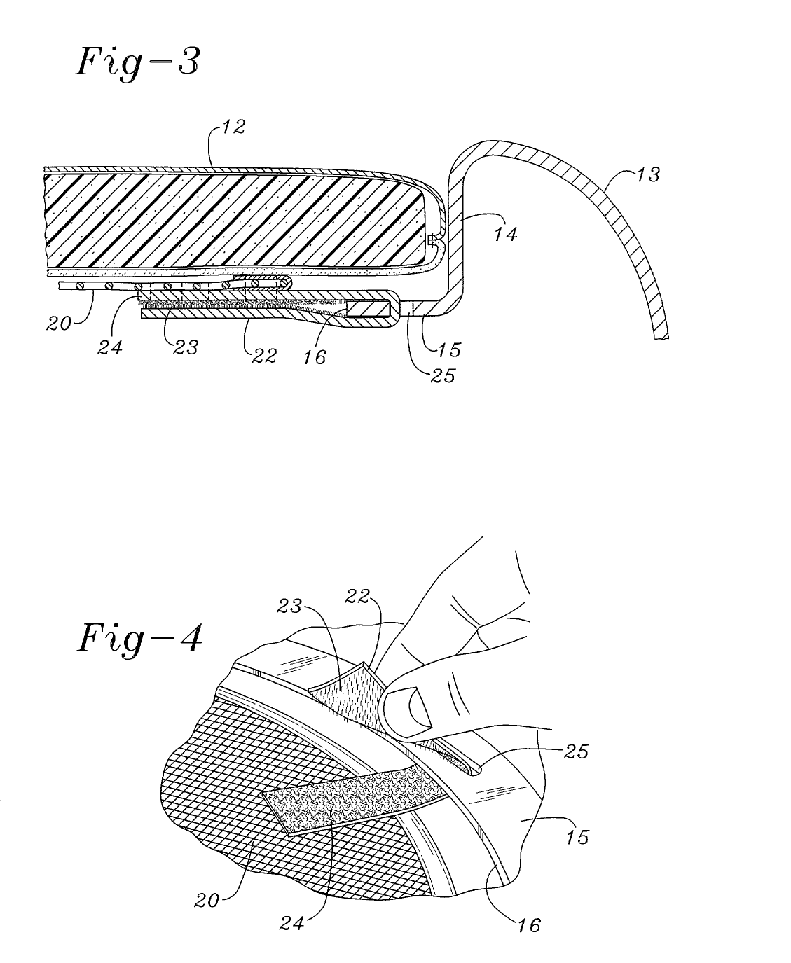

Referring to FIG. 1, there is shown a pet bed 10 having an upwardly extending base 11 which encircles an open center area. The open center area lies below a cushion 12 located in the upper portion of base 11. Base 11 is an oval-shaped piece of molded plastic material. The oval-shaped top profile is best seen in the top view of FIG. 5. Base 11 includes an outer wall 13 which extends between the top and bottom of the base 11. Base 11 also includes a shorter inner wall 14 (FIG. 2) which extends downward from the top of the base 11. Base 11 further includes a flange 15 (FIG. 2) which extends inward from the lower end of the inner wall 14. As such, flange 15 is located approximately midway between the top and bottom of the base 11. Flange 15 extends inward from the side of base 11 and encircles the open center area, the boundary of which is defined by the inner edge 16 of flange 15. The cross-sectional view of FIG. 3 shows more clearly t he relationship of the inner wall 14 to the flange 15 and the inner edge 16 of flange 15.

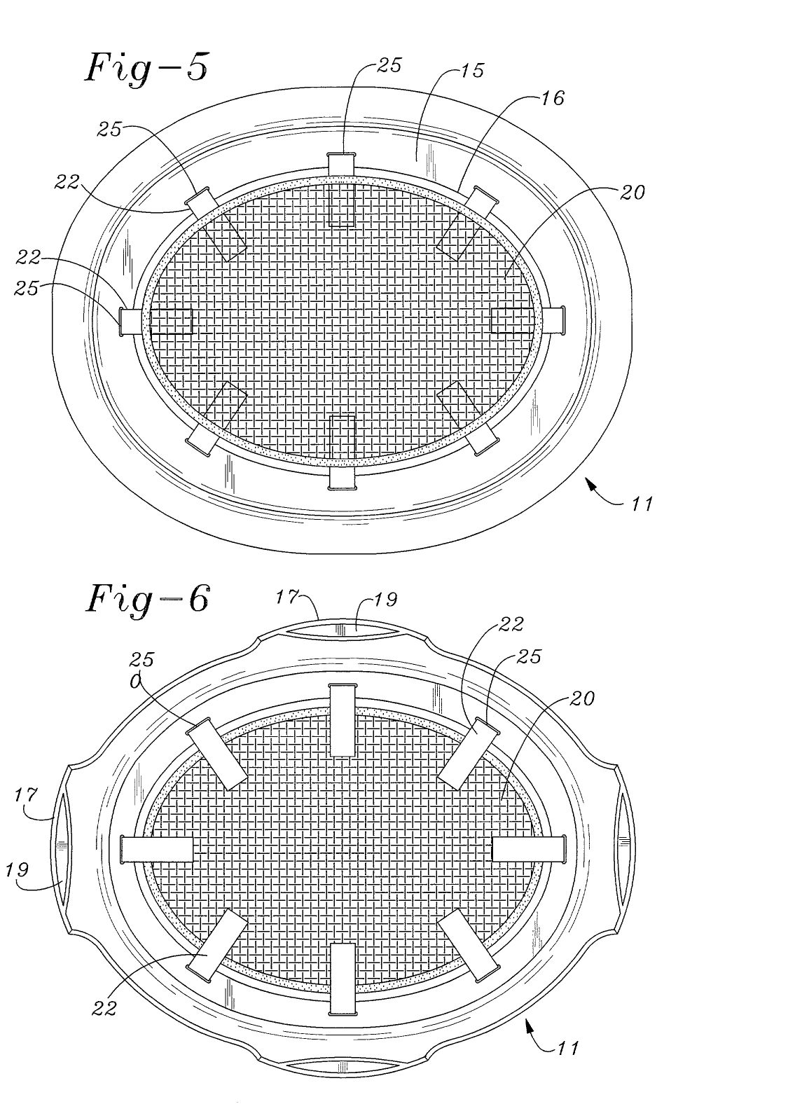

The base 11 is shaped to provide four downwardly extending leg portions 17 separated by intervening arch portions 18. The locations of the four leg portions 17 are shown in the bottom view of FIG. 6. If desired, anti-skid rubber inserts 19 may be mounted so as to extend slightly from the bottoms of the leg portions 17.

The pet bed 10 also includes a sheet of flexible material 20 which is sized and shaped to cover most of the open center area bounded by the inner edge 16 of flange 15. As seen in FIG. 3, the flexible material 20 is of oval shape, the same as is base 11. In the present embodiment, flexible material 20 is a woven mesh material made of synthetic fiber. A suitable form of such material is, for example, a nylon mesh material. The flexible material 20 may be coated with polypropylene, or the like, for waterproofing purposes.

The pet bed 10 further includes attachment members 22 for attaching peripheral portions of the flexible material 20 to the inner wall of the base 11 at a level partway (for example, approximately midway) up the base 11. In the present embodiment, these attachment members 22 take the form of elongated strap members each having one end 23 of the strap covered with hook fasteners and having the other end 24 covered with loop fasteners. This is best seen in the enlarged fragmentary view of FIG. 4. Hook and loop fasteners are well-known commercial items and are currently sold under the trademarked name VELCRO.

The inwardly extending flange 15 of the base 11 has a number of rectangular slots 25 cut completely through the thickness of the flange 15. The locations of these slots are shown in the top view of FIG. 5. In the illustrated embodiment, there are eight slots 25 evenly spaced around the path formed by flange 15. These slots 25 are used for attaching the straps 22 to the flange 15.

The method of attaching the flexible material 20 to the flange 15 is shown in FIGS. 3 and 4 for the case of one of the straps 22. A first end 24 of strap 22 is sewn onto the underside of an edge portion of flexible material 20. The free end 23 is passed through one of the flange slots 25 from above the flange 15 and doubled back on itself to engage its hook fasteners with the loop fasteners at the first end 24 of strap 22. The final engaged position is as shown in FIG. 3. Each of the other seven attachment straps 22 are mounted and secured in this same manner.

As seen in FIGS. 5 and 6, attachment straps 22 serve to suspend the flexible material 20 across the open center area of base 11. The hook and loop fasteners on the straps 22 enable the straps 22 to be adjusted to provide the desired tension for the flexible material 20. This construction is very much like the construction of a trampoline, but on a smaller scale.

As indicated in FIGS. 1 and 3, cushion 12 is supported by the upper side of flexible material 20 and is snugly fitted into the open center area of the base 11. This open center area is sized to be somewhat larger than the reclined body of an adult cat. The unique construction of pet bed 10 provides the proper support for the body of a cat or small dog. If desired, a plaything 27 may be suspended from a pole 28 mounted on the base 11.

While there has been described what is at present considered to be a preferred embodiment of this invention, it will be obvious to those skilled in the art that various changes and modifications may be made therein without departing from the invention and it is, therefore, intended to cover all such changes and modifications as come within the true spirit and scope of the invention.

What is claimed is:

1. A pet bed comprising:
an upwardly extending base which encircles an open center area;
a sheet of flexible material sized and shaped to cover most of the open center area;
and attachment members for attaching peripheral portions of the flexible material to the inner wall of the base at a level partway up the base.

2. A pet bed in accordance with claim 1 wherein the open center area of the base is somewhat larger than the reclined body of an adult cat.

3. A pet bed in accordance with claim 1 and including a cushion located in the open center area of the base and supported by the flexible material.

4. A pet bed in accordance with claim 1 wherein the base has an oval-shaped top profile.

5. A pet bed in accordance with claim 1 wherein the base is a piece of molded plastic material.

6. A pet bed in accordance with claim 1 wherein the base is an oval-shaped piece of molded plastic material.

7. A pet bed in accordance with claim 1 wherein the flexible material is attached to the inner wall of the base approximately midway between the top and bottom of the base.

8. A pet bed in accordance with claim 1 wherein the base includes:
an outer wall which extends between the top and bottom of the base;
a shorter inner wall which extends downward from the top of the base;
and a flange which extends inward from the lower end of the inner wall for use in attaching the flexible material to the base.

9. A pet bed in accordance with claim 1 wherein the flexible material is a mesh material.

10. A pet bed in accordance with claim 1 wherein the flexible material is a synthetic fiber mesh material.

11. A pet bed in accordance with claim 1 wherein the flexible material is a nylon mesh material.

12. A pet bed in accordance with claim 1 wherein the attachment members are strap members.

13. A pet bed in accordance with claim 1 wherein the attachment members are strap members having hook fasteners at one end and loop fasteners at the other end.

14. A pet bed in accordance with claim 1 wherein:
the base includes a flange which extends inward from the side of the base and encircles the open center area, such flange having a number of slots spaced around the open center area;
and the attachment members are straps which pass through the flange slots and are fastened to the flexible material.

15. A pet bed according to claim 14 wherein one end of each strap is covered with hook fasteners and the other end of each strap is covered with loop fasteners, a first end of each strap is bonded to an edge portion of the flexible material and the other end passes through a flange slot and doubles back to the flexible material to engage its fasteners with the fasteners at the first end of the strap.

16. A pet bed comprising:
an upwardly extending base which encircles an open center area somewhat larger than the reclined body of an adult cat;
a sheet of flexible material sized and shaped to cover most of the open center area;
attachment straps attaching peripheral portions of the flexible material to the inner wall of the base at a level partway up the base;
and a cushion supported by the upper side of the flexible material and snugly fitted into the open center area of the base.

17. A pet bed comprising:
an upwardly extending oval-shaped molded plastic base which encircles an open center area somewhat larger than the reclined body of an adult cat, such base including a mid-level flange which extends inward from the side of the base and encircles the open center area, such flange having a plurality of slots therein spaced around the open center area;
a sheet of flexible material sized and shaped to cover most of the open center area;
a plurality of attachment straps which individually pass through different ones of the flange slots and are fastened to the flexible material for suspending the flexible material across the open center area;
and a cushion supported by the upper side of the flexible material and snugly fitted into the open center area of the base.

18. A pet bed in accordance with claim 17 wherein the base includes:
an outer wall which extends between the top and bottom of the base;
and a shorter inner wall which extends downward from the top of the base;
the mid-level flange being connected to the lower end of the inner wall and extending inward therefrom.
